(19) United States
(12) Patent Application Publication
(10) Pub. No.: US 2008/0106984 A1
(43) Pub. Date: May 8, 2008

(54) Actuator Position Control Method and Corresponding Apparatus

(75) Inventors: Ivon Franciscus Helwegen, Eindhoven (FR); Anthonius Petrus Janssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/559,836

(22) PCT Filed: Jun. 8, 2004
(86) PCT No.: PCT/IB04/01960

§ 371 Date: Dec. 8, 2005

(30) Foreign Application Priority Data
Jun. 12, 2003 (EP) 03300030.8

(51) Int. Cl. G11B 7/00

(52) U.S. Cl. 369/44.32

(57) ABSTRACT

The invention relates to an actuator position control method for use in a recorded information reproducing apparatus. Front, main and rear beams are directed onto a recorded track formed on a rotating optical recording medium and respective first, second and third signals are produced in response to light reflected by said recorded track when scanned by the front, main and rear beams. The control method comprises the steps of producing from a source of light said beams; scanning with said main beam the recorded track; controlling the position of said main beam with respect to the recorded track in response to position control signals generated from said first and third signals, and reading the recorded information by means of a processing operation of said second signal. According to the invention, said method also comprises the steps of scanning in advance, with the front beam, a portion of recorded track which is located in front of the portion of recorded track that will be later, after a predetermined delay, scanned by the main beam; and, on the basis of signals generated in response to the occurrence of possible defects, cancelling the effects of the variations of said first and third signals, subsequent to variations of reflected light caused by said defects, by means of a modification of the position control signals for controlling the position of said main beam.

### FIELD OF THE INVENTION

The present invention relates to an actuator position control method for use in a recorded information reproducing apparatus in which front, main and rear beams are directed onto a recorded track formed on a rotating optical recording medium and respective first, second and third signals are produced in response to light reflected by said recorded track when scanned by said front, main and rear beams, said method comprising the steps of:
producing from a source of light said front, main and rear beams;
scanning with said beams the recorded track;
controlling the position of said main beam in response to position control signals generated by said first and third signals;
reading the recorded information by means of a processing operation of said second signal.

### The invention may be applied to all optical disc drives that make use of a rotating optical disc (DVD, Blu-ray disc, Small form Factor Optical disc, . . . )

### BACKGROUND OF THE INVENTION

An optical disc player such as the one described for instance in the document U.S. Pat. No. 4,722,079 comprises inter alia a servo circuit in which three optical beams including a main optical beam, emitted for example by a laser oscillator, and two additional ones are used and said main optical beam is caused to correctly follow a track on a disc, in order to read data recorded on it. The optical disc comprises a lot of recording tracks, only five ones (T−2, T−1, T, T+1, T+2) being considered in the following description.

The enclosed FIG. 1 is a diagram illustrating an example of positional relations between these five successive tracks of the recording disc and beam spots 11 to 13. The main beam, corresponding to the central spot 12, is provided for reading the data recorded on the track T of the disc, while the additional beams (corresponding to the spots 11 and 13)—a front beam, located in front of the main one with respect to the reading direction indicated at the top of the figure by the arrow, and a rear one, located after said main beam with respect to the reading direction—generate together radial error signals used to control that the main beam follows the current track T. The reference letter “L” designates the distance between the beam spots. A radial servo provided in the disc player then drives an actuator (not shown) in reply to said radial error signals, received via an appropriate differential amplifier (it can be noted that FIG. 1, in which the front and rear beam spots are placed on the two neighbouring tracks with respect to the current one, illustrates only one possibility of detection, but that other ones are known, for example a three-spots push-pull detection, in which said spots are placed on the neighbouring lands between two tracks).

When an external disturbance is applied to the optical disc player, the three beams are moved in the same direction, but the front beam and rear beam outputs change in phase opposition, since the parts of the front beam and the rear beam on the current track T respectively increase and decrease. As a result, the actuator is driven so as to return the main beam to the central line of said track T. The described three-beam type optical disc player is therefore only organized so that the successive tracks on the disc are correctly followed and the data recorded on the disc correctly read.

Recording information on optical discs at higher and higher densities has then led to narrow the track pitch, which is however limited by the diameter of the beam focused on the disc. A signal from a main track (the current one) is undesirably accompanied by signals from adjacent tracks when the track pitch is narrowed without changing the beam diameter. An increasing inter-tracks interference, or crosstalk, from the adjacent tracks occurs and reduces the signal-to-noise ratio, which makes more difficult to reproduce the recorded data accurately.

Under such circumstances, also three-beam type optical pick-up devices have been employed for cancelling or at least reducing such effects. Among three adjacent recording tracks of the disc, the center recording track is irradiated with a main reading beam and a corresponding center beam spot is formed on the track T. Similarly, adjacent reading beams—a front one and a rear one—are irradiated on the adjacents tracks T−1 and T+1, the front beam being directed in front of the main beam and irradiated on the track T−1 while the rear one is directed to the rear of the main beam and irradiated on the track T+1, and beam spots are formed on these adjacent tracks (T−1) and (T+1). While reading the signal associated to the main track, a crosstalk signal is produced, based on an output of received light reflected by the adjacent tracks, and subtracted from the signal read from the main track, in order to produce, thanks to crosstalk signal correction circuits, a main track signal in which the effect of the crosstalk from the adjacent tracks has been removed or at least reduced. It can be noted, moreover, that the effect of the crosstalk from the adjacent tracks on the main track and therefore the cancellation or at least the reduction of said crosstalk vary in their degree depending on the state of the main track, i.e. for instance whether there is a pit or a mirror on said main track.

On optical discs, however, defects may sometimes occur (such as fingerprints, scratches, etc). When such defects occur, it is important that the servo system of the disc drive keeps working as good as possible, so that the drive does not loose the track. Many drives are equipped with a defect detector that keeps the servo system stiff when a defect occurs and lets it continue from the place where it is kept when the defect is over. In such a situation, the servo has to work hard to get to the correct position again, which results in some noticeable time before the system is in lock again and bits can again be detected. Additionally, it also results in power consumption and acoustical noise.

### SUMMARY OF THE INVENTION

It is therefore an object of the invention to propose a method and apparatus in which this drawback is avoided.

To this end, the invention relates to a control method such as defined in the introductory paragraph of the description and which is moreover characterized in that it also comprises the steps of:
scanning in advance, with the front beam, a portion of recorded track which is located in front of the portion of recorded track that will be later, after a predetermined delay, scanned by the main beam;
on the basis of signals generated in response to the occurrence of possible defects detected by said front beam on said front portion of recorded track, cancelling the effects of the variations of said first and third signals, subsequent to variations of reflected light caused by said defects, by means of a modification of the position control signals generated for controlling the position of said main beam.

The present invention allows to solve the problem mentioned above, since the preliminary detection of the occurring defect before said defect reaches the other following spots is used to immediately adapt the normalization and avoids the peaks observed in the error-signals.

### BRIEF DESCRIPTION OF THE DRAWINGS

The present invention will now be described, by way of example, with reference to the accompanying drawings in which:

FIG. 1 is a diagram illustrating an example of positional relations between the tracks of the disc and the beam spots;

FIG. 2 is a schematic illustration of the components of a servo system in an optical disc drive;

FIG. 3 is a graphical illustration (FIGS. 3A to 3D) of error signals when a defect appears on the recorded track of a recorded medium such as an optical disc;

FIG. 4 illustrates an embodiment of the structure according to the invention;

FIGS. 5 to 8 illustrate the action of the structure according to the invention.

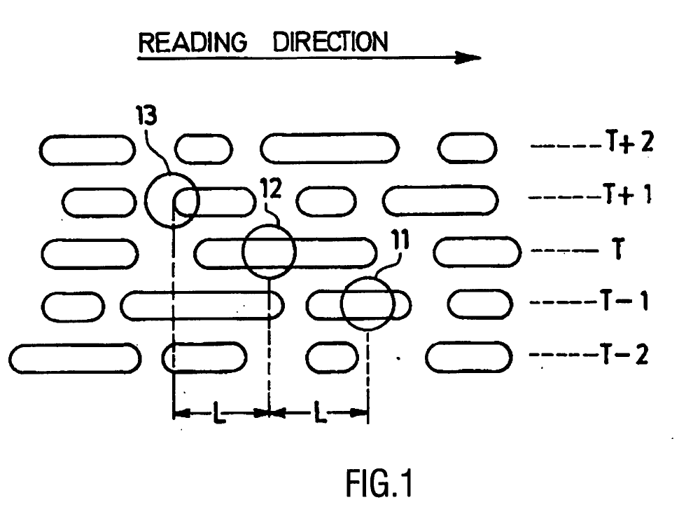

### DETAILED DESCRIPTION OF THE INVENTION

An example of embodiment of the invention will now be described below. As said above, when defects occur on optical discs, it is important that the servo system of the disc drive keeps working as good as possible. When a defect has occurred, less laser light is reflected from the disc than in a normal situation and the signal coming from photodetectors (and used as a measure for the reflected laser light) comes below a predefined threshold. A defect detector is then switched on and the servo system is kept stiff until the signal again comes above its threshold level.

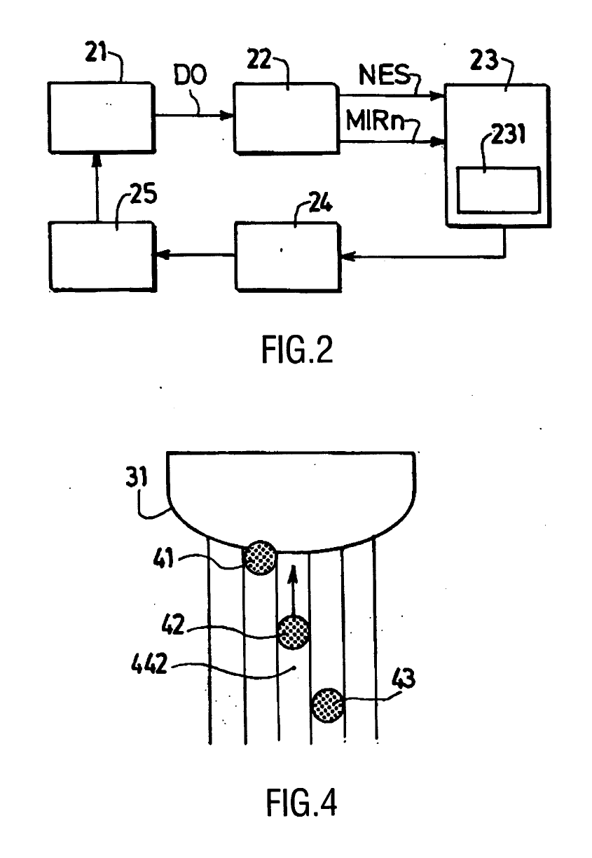

These operations take place in a servo control system. As illustrated in FIG. 2, the servo system of an optical disc drive schematically comprises an optical system 21, followed by a preprocessing circuit 22 receiving the detector outputs DO from the optical system 21 and sending its outputs to a servo control system 23, including inter alia a defect detector 231. The output of the servo control system 23 is sent to actuator drivers 24 that control actuators 25 acting themselves on the optical system 21.

In the preprocessing circuit 22, generation and normalization operations of the error signals take place, leading to normalized error signals NES that are sent towards the system 23. The system 23 also receives the mirror signal, also called MIRn when normalized to the laser power, which is the sum of the signals coming from all the detectors and is used as a measure for the reflected laser light. If a classical four-quadrant detector (including four quadrants A, B, C, D with respective photodetectors on which the reflection light from the beam spots is irradiated) is used, the normalized focus error FEn is generated for instance like indicated in the equation (1):

$$FEn = \frac{( A + B ) - ( C + D )}{A + B + C + D} \qquad ( 1 )$$

When a defect occurs, the amount of light that is returned decreases and the denominator of FEn may reach 0, which means that the error levels become very high and that the system gets unstable. To prevent from this, also dropout detection is used in the preprocessing circuit 22. When the denominator comes below a predetermined threshold, the normalization is adapted, so that the error levels do not depend on the amount of light that comes back anymore.

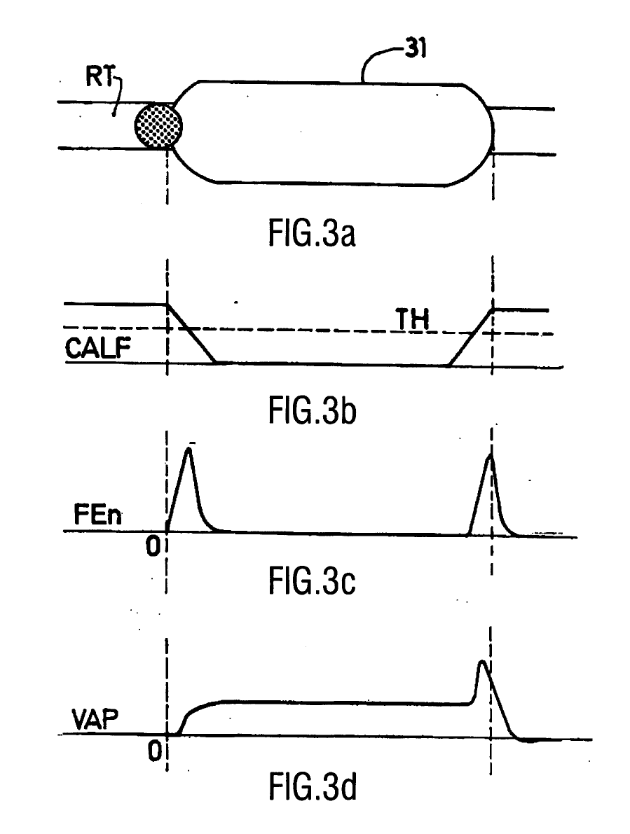

However, before the denominator reaches the threshold level, already some peaks may occur in the error-signals, at the beginning and/or at the end of the defects, and cause offsets in the actuator positions. This situation is illustrated in FIGS. 3A to 3D, which give graphical representations of error signals when a defect occurs on the recorded track RT (this defect is designated by the reference 31 in FIG. 3A): CALF (FIG. 3B) designates the sum of the signals coming from all the detectors, FEn (FIG. 3C) shows two peaks that occur in the error-signals when the signal CALF comes below a predetermined threshold TH, and FIG. 3D illustrates the corresponding variation VAP of the actuator position from the desired position.

According to the invention, the front beam spot, corresponding to the front beam directed in front of the main beam, is used as a kind of antenna for defects. The amount of light that is reflected by this spot can tell whether a defect is coming in or not: a defect is detected before the system runs in to this defect, and the preprocessor or the servo controller provided in the reproducing apparatus knows by forehand that a defect is coming. Taking into account the reading linear velocity for the recording disc, the normalization can therefore be adapted, so that the peaks in the error signals will not occur anymore.

A proposed embodiment of the invention is illustrated in FIG. 4. A laser beam emitted from a laser oscillator is divided into three information reading beams through a grating for instance, and the three beams are irradiated on the disc, shown from above in FIG. 4. As also shown in FIG. 4, three beam spots 41, 42, 43 are formed on the recording disc by the three information reading beams, and, when the center spot 42 corresponding to the main beam is formed on a track 442, the two other spots 41 and 43 are formed on one side and the other one of said spot 42, and respectively in front of it and to the rear of it. The occurring defect is designated by the reference 31 (in fact, with respect to FIG. 3, only a part of said defect is shown). As the front beam spot 41 precedes the main center beam in the scanning direction, it can scan in advance the portion of recorded track that will be later—after a defined delay—scanned by the main beam. Therefore, when the recording surface of the recording disc is scanned by the main center beam, accompanied by the associated front and rear beams, and there is a defect on said recording surface, the amount of light reflected by said front beam at the place of said defect changes, and this modification is therefore known before the system runs into this defect and the three reading beams are together affected. More precisely, when the front end of the defect begins to be detected by the spot 41, a signal is sent towards the preprocessing circuit 22 in order to immediately adapt the normalization performed therein, so that the peaks in the error signals are compensated and offsets in the actuator positions can no longer be caused.

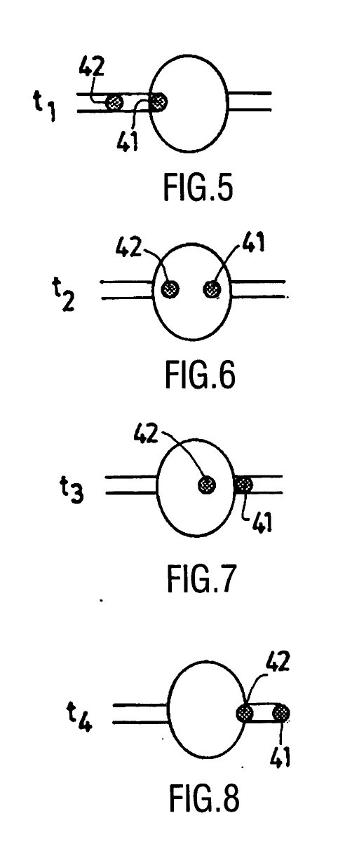

A graphical illustration of the action of the spot 41 may be given in FIGS. 5 to 8. In FIG. 5, at a time t1, the spot 41 placed ahead from the center spot 42 enters the defect: the defect, also designated by the reference 31, is detected in advance. Bits can still be detected, and no change in the normalization has still to be performed, since error signals only concern the spot 41. However, taking into account the distance between said spots 41 and 42 and therefore the time difference between the signals generated in correspondence with the reflected beams associated to these spots, the preprocessing circuit is informed that normalization will have to be modified.

At a time t2 (FIG. 6), the center spot 42 in turn enters the defect: no bit detection is now possible, and the signal previously sent at the time t1 to the preprocessing circuit 22 (after the defect detection has occurred thanks to the front beam) switches on the modification of the normalization in order to cancel the effects of the peak associated to the frond end of the defect.

At a time t3 (FIG. 7), the spot 41 goes out of the defect: the end of the defect is detected, while the center spot 42 is still within said defect, and consequently no bit detection is still possible. Finally, at a time t4 (FIG. 8), the center spot 42 in turn goes out of the defect: the signal previously sent at the time t3 to the preprocessing circuit 22 (after the detection of the rear end of the defect has occurred thanks to the front beam) switches on the modification of the normalization in order to cancel the effects of the peak associated to said rear end.

1. An actuator position control method for use in a recorded information reproducing apparatus in which front, main and rear beams are directed onto a recorded track formed on a rotating optical recording medium and respective first, second and third signals are produced in response to light reflected by said recorded track when scanned by said front, main and rear beams, said method comprising the steps of:
producing from a source of light said front, main and rear beams;
scanning with said main beam the recorded track;
controlling the position of said main beam with respect to the recorded track in response to position control signals generated by said first and third signals;
reading the recorded information by means of a processing operation of said second signal;
said method being further characterized in that it also comprises the steps of:
scanning in advance, with the front beam, a portion of recorded track which is located in front of the portion of recorded track that will be later, after a predetermined delay, scanned by the main beam;
on the basis of signals generated in response to the occurrence of possible defects detected by said front beam on said front portion of recorded track, cancelling the effects of the variations of said first and third signals, subsequent to variations of reflected light caused by said defects, by means of a modification of the position control signals generated for controlling the position of said main beam.

2. An apparatus for reading an optical recording medium on which information is recorded on at least one track, said apparatus being of the type comprising:
means for generating from a light source front, main and rear beams directed onto said recorded track;
means for scanning with said main beam the recorded track;
means for producing respective first, second and third signals in response to light reflected by said recorded track when scanned by said front, main and rear beams;
means for generating position control signals from said first and third signals;
means for controlling the position of said main beam with respect to the recorded track in response to said position control signals;
means for reading the recorded information by means of a processing operator of said second signal;
said apparatus being further characterized in that it also comprises:
means for scanning in advance, with the front beam, the portion of recorded track later scanned, after a predetermined delay, by the main beam;
means for cancelling, on the basis of signals generated in response to the occurrence of possible defects detected by said front beam on said portion of recorded track, the effects of the variations of said first and third signals, subsequent to variations of reflected light caused by said defects, by means of a modification of the position control signals generated for controlling the position of said main beam.
